(19) United States
(12) Patent Application Publication
(10) Pub. No.: US 2006/0052045 A1
(43) Pub. Date: Mar. 9, 2006

(54) Container for coins or tokens

(75) Inventor: Janni Lambert, St-Nicephore (CA)

Correspondence Address: OGILVY RENAULT LLP, 1981 MCGILL COLLEGE AVENUE, SUITE 1600, MONTREAL, QC, H3A2Y3, CA

(73) Assignee: CASCADES INC., Kingsey Falls (CA)

(21) Appl. No.: 10/934,432

(22) Filed: Sep. 7, 2004

(51) Int. Cl. G07D 9/00; G07D 9/04

(52) U.S. Cl. 453/60

(57) ABSTRACT

The present invention relates to a coin container comprising at least one compartment adapted to receive a predetermined number of coins or tokens of a predetermined denomination stacked side-by-side therein. The at least one compartment includes at least one longitudinal side wall and end faces at opposed ends of the at least one longitudinal side wall and at least one protuberance projecting longitudinally inwardly of the at least one compartment. The protuberance is axially deflectable under the pressure of the coins or tokens into a predetermined position indicative of a reaching of a full content capacity of the container.

### BACKGROUND OF THE INVENTION

1) Field of the Invention

The present invention relates to a coin container for holding a predetermined number of coins or tokens and, more particularly, to a coin container coins contained therein.

2) Description of the Prior Art

Various types of coin containers (or coin holders) have been provided. For example, U.S. Pat. No. 4,183,432 discloses a transparent coin container comprising two semi-cylindrical open-faced receptacles formed from a transparent plastic material. The semi-cylindrical receptacles are interconnected along a common edge parallel to a longitudinal axis of the semi-cylindrical receptacles. Semi-circular end walls are provided at opposite ends of each receptacle. The semi-cylindrical receptacles are hinged toward one another in order to form a cylindrical cavity of a predetermined length so as to receive therein a predetermined number of coins. An outer surface of a first one of the semi-cylindrical receptacles has protrusions thereon, whereas a flap hinged to an outer edge of a second one of the semi-cylindrical receptacles has indentations that will be in register with the protrusions by hinging the flap over the first one of the semi-cylindrical receptacles when the semi-cylindrical receptacles are opposed to receive coins therebetween. Accordingly, the protrusions and the indentations matingly engage with one another thereby securing the semi-cylindrical receptacles with one another.

U.S. Pat. No. 5,957,275 discloses a container made of a moldable plastic sheet. The container comprises three semi-cylindrical receptacles, each defining two compartments. Each of the semi-cylindrical receptacles has semi-circular end faces at ends thereof. A first one of the semi-cylindrical receptacles, preferably the middle one, is adapted to receive therein coins. The two compartments of the middle semi-cylindrical receptacle separate the coins into two portions. Once coins are positioned in the first semi-cylindrical receptacle, a second one of the semi-cylindrical receptacles is hinged towards the middle semi-cylindrical receptacle to form a cylindrical cavity wherein the coins will be in captive engagement. The third one of the semi-cylindrical receptacles is hinged toward the cylindrical receptacle holding the coins so as to engage a detachable engagement therewith, via mating connectors on the semi-circular ends thereof.

In designing containers for coins or tokens, a plurality of factors must be taken into account. One such factor is the lack of consistency in the thickness of the tokens or coins for which the containers are designed. Coins of a same type and value are struck according to thickness tolerances. For this reason, a container receiving a plurality of coins struck at the upper end of the thickness tolerance will most likely be too short for such coins and contain less coins than the predetermined number. Older coins can also be thinner because of the wear and tear they have sustained over time. Another factor resides in that countries may change thickness standards for their coins, whereby some newer coins may be thicker or thinner than older coins. Also, some countries have changed monetary systems, and this may cause other problems. For instance, most of the countries forming the European community have now decided to use the euro. The euro coins are struck in a few countries and a lack of thickness consistency has been reported. For these reasons, the number of coins in the containers can often be off by a few units.

To reduce the risks of having more or less tokens in a container than the predetermined number, U.S. Pat. No. 4,715,492 discloses a hinged coin container having two semi-circular parts hinged together at a common edge and releasably joined at the other. The coin container is improved by the provision of a plurality of internal pockets or compartments which are dimensioned to receive no greater than a predetermined number of coins of a specific denomination, irrespective of the thickness of the coins, so that the maximum desired number of coins may be unerringly packaged in the container.

However, the addition of separators between the compartments increases the total length of the container. The coin containers are stored and transported in boxes adapted to contain a predetermined number of containers. Therefore, different boxes have to be used with containers having compartments therein, the dimension of each box being adapted to the length of the coin containers. Containers having or not separators therein cannot be mixed in a same box.

### SUMMARY OF THE INVENTION

It is an object of the present invention to provide a coin container adapted to contain a predetermined number of coins.

One aspect of the invention provides a coin container comprising at least one compartment adapted to receive a predetermined number of coins or tokens of a predetermined denomination stacked side-by-side therein. The at least one compartment includes at least one longitudinal side wall, end faces at opposed ends of the at least one longitudinal side wall, and at least one protuberance projecting inwardly of the at least one compartment. The protuberance is axially deflectable under the pressure of the coins or tokens into a predetermined position indicative of a reaching of a full content capacity of the container.

Another aspect of the invention provides a coin container comprising at least two open-faces receptacles connected along a common edge. Each receptacle includes a longitudinal side wall having an inner surface; an end wall at opposite ends of each of the longitudinal arcuate side wall, the end walls cooperating with the side wall to circumscribed a cavity adapted to receive an exact number of coins of a predetermined denomination therein; and at least one of the receptacles including at least one loading gauge displaceable under the pressure of the coins to a position indicating that the exact number of coins has been loaded into the coin container.

A further aspect of the invention provides a coin container comprising at least two open-faces receptacles connected along a common edge. Each receptacle includes at least one cavity adapted to receive an exact number of coins of a predetermined denomination therein and at least one of the receptacles including at least one coin indicator, the at least coin indicator being substantially deformable under the pressure of the coin to indicate that the exact number of coins have been inserted in the receptacle.

In this specification, the term “coin” is intended to mean a token or any disk shaped-like objects.

### BRIEF DESCRIPTION OF THE DRAWINGS

Further features and advantages of the present invention will become apparent from the following detailed description, taken in combination with the appended drawings, in which:

FIG. 1 is a top perspective view of a coin container shown in an open or deployed position in accordance with an embodiment of the invention;

FIG. 2 is a bottom perspective view of the coin container shown in FIG. 1;

FIG. 3 is a perspective view of the coin container shown in a closed position and containing coins therein;

FIG. 4 is a perspective view of a coin container in accordance with another embodiment of the invention;

FIG. 5 is a top plan view of a coin container in accordance with still another embodiment of the invention, wherein the container is in a deployed position;

FIG. 6 is a side elevation view of the coin container shown in FIG. 5; and

FIG. 7 is a front elevation view of the coin container of FIG. 5, wherein the container is in a folded position and contains coins therein.

It will be noted that throughout the appended drawings, like features are identified by like reference numerals.

### DETAILED DESCRIPTION OF THE PREFERRED EMBODIMENT

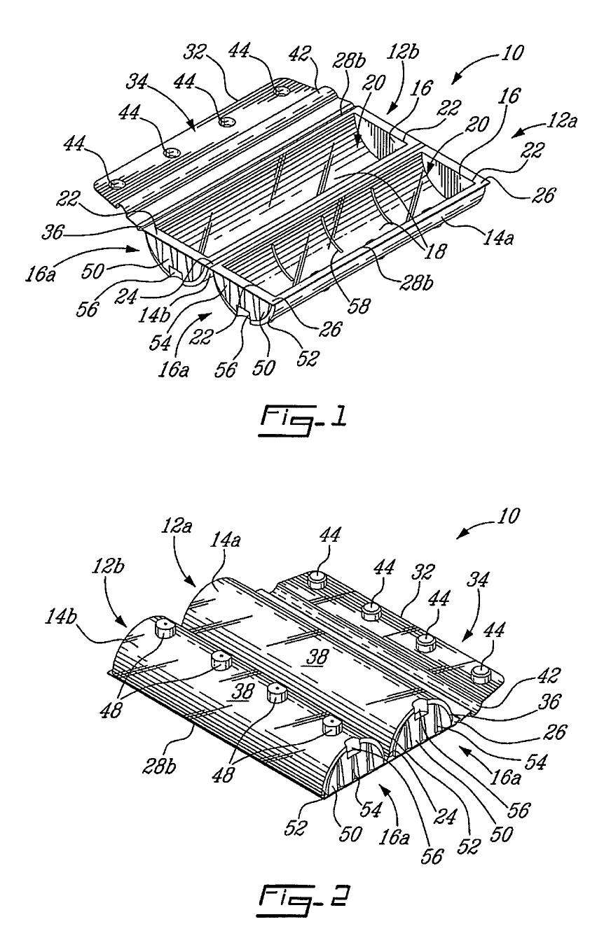

Referring now to the drawings, and more particularly to FIGS. 1 and 2, there is shown at 10 an example of a coin container, or a coin holder, in a deployed (or open) position. The coin container 10 is formed from a sheet of transparent plastic material molded into a pair open-faced receptacles 12a, 12b. Each receptacle 12 has a longitudinal arcuate side wall 14 and two substantially semi-circular end walls 16 at opposed ends of the longitudinal side wall 14. The longitudinal side wall 14 has an inner surface 18 that cooperate with the end walls 16 to circumscribed a substantially semi-cylindrical cavity 20. The end walls 16 define a straight outer edge 22 extending on the diametrical plane of the cavities 20.

Both receptacles 12 are disposed in a side-by-side relationship and are interconnected along a common dividing wall 24 parallel to the longitudinal axis of the receptacles 12. One skilled in the art will appreciate that the dividing wall 24 can be replaced by a folding edge or live hinge (not shown) interconnecting both receptacles 12. To add rigidity to the container 10, a peripheral flange 26 extends outward of the receptacles 12 from the outer longitudinal edges 28 of the longitudinal side wall 14 and the straight outer edges 22 of the end walls 16.

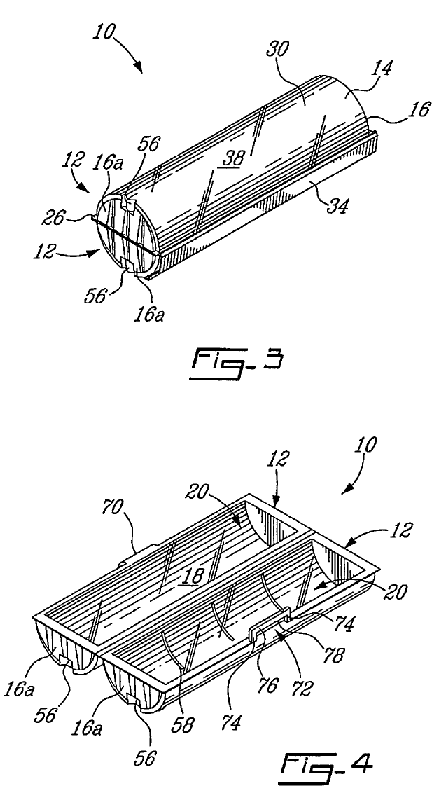

The dividing wall 24 acts as a hinge for allowing the receptacles 12 to be folded or pivoted towards one another as shown in FIG. 3. In the folded position, the receptacles 12 define a closed cylindrical compartment 30 wherein coins of a predetermined denomination can be stacked side-by-side as it will be explained more in detail later. A hinge rib (not shown) can be molded across the dividing wall 24 and the peripheral flange 26 to facilitate hinging of the receptacles 12 in a juxtaposed position (or folded position).

Attachment means are provided to detachably secure the receptacles 12 in juxtaposition. In FIGS. 1-3, the attachment means include a flap 34 extending outwardly of an outer longitudinal edge 28b of the side walls 14b of one of the receptacles 12b. Herein, the edge 28b is provided with a hinged rib 36 which facilitates folding the flap 34 over the outer face 38 of the opposite receptacle 12a and accommodating a portion of the peripheral flange 26 extending outward from the outer longitudinal edge 28a of the side wall 14a of the receptacle 12a. A longitudinal expansion ridge 42 is formed longitudinally across the flap 34 and disposed parallel between the end edge 32 and the rib 36. A row of longitudinally spaced-apart indentations 44 are molded adjacent the end edge 32 of the flap 34. A corresponding row of outward longitudinally spaced-apart protrusions 48 are formed in the side wall 14a of the receptacle 12a. Preferably, the outward protrusions 48 are located on the apex of the longitudinal side wall 14a. When the receptacles 12a, 12b are juxtaposed, the flap 34 is folded over the outer surface 38 of the receptacle 12a and the protrusions 48 are received in a respective indentation 44 of the flap 34. The position of the indentations 44 on the flap 34 are such that the indentations 44 are in registry with the protrusions 48. When the protrusions 48 matingly engage the Indentations 44, the longitudinal expansion ridge 42 allows a slight expansion whereby in its secured position, a retention force will be exerted on the protrusions 48 received in the indentations 44 by the ridge 42 to provide a more secure attachment means.

Referring back to FIGS. 1 and 2, it will be seen that the end walls 16 slope outwardly towards a top edge of the receptacle 12 in a sloping portion 50 thereof. An end rib portion 52 is formed in the end walls 16, transverse to the side wall 14, in at least a portion thereof, although hereinshown fully along the interconnecting edge of the end wall 16 and the side wall 14. The distance between opposed end ribs 52 of a receptacle 12 is precisely the distance required to stack a predetermined quantity of coins of a predetermined denomination therein. Although the end walls 16 have a sloping portion 50, it is not possible to insert an extra coin in the container 10, if all the coins inserted have the exact predetermined thickness, as there will be no spacing between the end ribs 52 and the resiliency in the plastics material of the sloping portion 50 of the side wall 16 will not permit the coin to be inserted in the receptacle 12.

A plurality of structural ribs 54 are provided in the sloping portion 50 of the end walls 16 to add rigidity to the container 10. The purpose for providing an end wall 16 with a sloping portion 50 is to permit the nesting of the coin containers 10, one within the other when they are not used.

Referring back to FIGS. 1 and 2, there is shown that both receptacles 12 include a protuberance 56 juxtaposed to an end wall 16a, on the apex of the longitudinal side wall 14, protruding inside the cavities 20. The protuberances 56 of both receptacles 12 are juxtaposed to the end wall 16a located at the same corresponding end of the longitudinal side walls 14.

As mentioned earlier, each container 10 is adapted to contain a predetermined number of coins, or tokens, of a predetermined denomination. Therefore, the length of the longitudinal side wall 14 and the diameter of the receptacles 12 are adapted In accordance with the thickness and the diameter of the specific coins to be contained therein. However, the thickness of the coins can vary slightly. Therefore, a container 10 can include less coins than the predetermined number. The length of the protuberances 56 is adapted in a manner such that the protuberances 56 act as coin indicators and are compressed or deformed only when one of the receptacle 12 includes the predetermined number of coins therein. Preferably, the protuberances 56, or coin indicators, are deformed only when the juxtaposed receptacle 12 is folded towards the first one as shown in FIG. 3. If the cylindrical compartment 30 includes less than the predetermined number of coins therein, the protuberance 56 is not compressed.

Referring back to FIG. 1, there is shown that the outer surface 38 of the side wall 14 includes a coin scale 58 molded thereon as an identification marking, so that the user can quickly look at the coin scale and see how many coins are enclosed in the coin container 10 at any time.

Although not shown, the outer surface 38 of the side wall 14 may be molded with a rough texture in at least a portion thereof whereby when a plurality of such coin containers are strapped together by an elastic band, they provided better retention and do not slip out of such attachment. The protrusions resulting from the outer surfaces of the indentations 44 will also provide retention between these. Further, although not shown, in order to identify proper denomination of coins to be inserted in a container 10, the plastics material of the entire container may have a color pigment therein, each color being associated with a denomination, or the coin denomination can be molded on the outer surface of one of the receptacle 12.

In a modification of the embodiment described hereinabove, the attachment means can be constituted by merely a piece of tape or hook and loop material bridging both longitudinal edges 28 of the receptacles 12 when juxtaposed and in such case, the flap 34 would not be necessary.

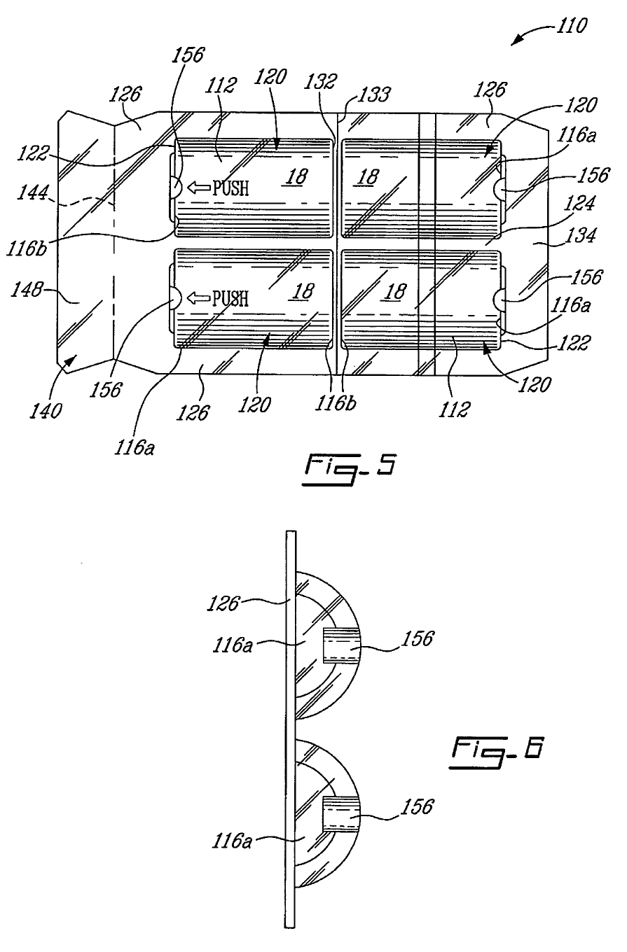

Referring now to FIG. 4, there is shown another embodiment of the coin container 10 having different attachment means. The attachment means include a latch lip 70 and a U-shaped latch member 72 which are integral with a respective outer longitudinal edge 28. The latch lip 70 extends outward radially and is preferably integrally formed on the outer surface 38 of the longitudinal wall 14, adjacent to the longitudinal edge 28. The upper side of the latch lip 70 curves downwardly to meet the flat lower side of the latch lip 70. The latch lip 70 is centrally located relatively to the longitudinal axis of the receptacle 12. The latch member 72 is also located midway between opposed ends of the other receptacle 12. The latch member 72 includes two spaced-apart, transverse, side arms 74 which are integrally formed on the outer surface 38 of the receptacle 12 and extend tangentially outward therefrom. The outer ends of the transverse side arms 74 are connected by a longitudinally extended, integral latch arm 76 which functions with the side arms 74 to form the U-shaped latch member 72. When both receptacles 12 are juxtaposed, the latch lip 70 moves into the space 78 formed between the U-shaped latch member 72 and the longitudinal edge 28, and it snaps into that space 78. The structure is such that it permits a slight outward bending or flexing of the latch member 72 when the two receptacles 12 are moved together to permit the latch lip 70 to slide under the latch longitudinal arm 76 and then into position within the space 78.

Each cavity 20 of the container 10 shown on FIG. 4 includes a protuberance 56 juxtaposed to an end wall 16 of the receptacle 12, protruding inside the cavity 20. As for the previously described embodiment, the protuberances 56 are deflectable under the pressure of the coins or tokens into a predetermined position indicative of a reaching of a full content capacity of the container 10.

Referring now to FIGS. 5-7, there is shown another embodiment of a coin container 110. The coin container 110 has two open-faced receptacles 112 molded from a sheet of transparent plastic material. Each receptacle 112 has an inner surface 118 defining two substantially semi-cylindrical cavities 120. The cavities 120 are disposed in a side-by-side relationship and define a common dividing wall 124 between them. Semi-circular transverse end walls 116 are provided at opposed ends of each cavity 120 and define a straight outer edge 122 extending on the diametrical plane of the cavities 120.

To add rigidity to the container 110, a peripheral flange 126 extends diametrically outward of the receptacles 112 from the longitudinal edges 128 of the side wall 20 of the receptacle 12 and the straight outer edge 122 of the end walls 116.

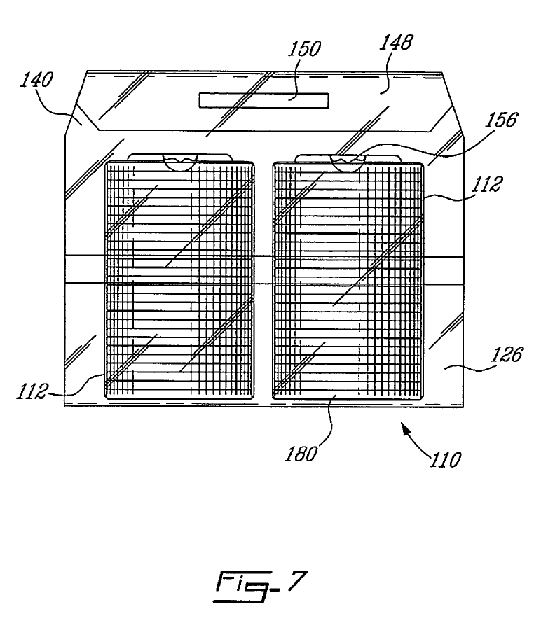

As seen in FIG. 6, the dividing wall 124 has a top edge 129 extending in a plane below the common plane of the peripheral flange 126 to add stability and rigidity to the cavities 120 in the receptacles 112.

The receptacles 112 are positioned end-to-end to one another and spaced closely at their adjacent ends 116b to define a common folding edge or hinge 132 therebetween. A hinge line 133 is molded across the peripheral flange 126 axially aligned with the hinge 132 to facilitate hinging one receptacle 112 in juxtaposition to the adjacent receptacle 112.

As for the previously described embodiments, attachment means are provided to detachably secure the receptacles 112 at an opposed edge of the receptacles 112 to the hinge 132. An example of the attachment means includes a tab 134 formed integral with the peripheral flange 126 and extending outwardly of the transverse end wall 116 of the cavities 120 along the edge 122. A folding flap 140 is formed integral with the peripheral flange 126 and extends outwardly from the end walls 116a of the cavities 120. The folding flap 140 is approximately twice the width of the tab 134 and has a fold line 144 extending longitudinally and centrally of the flap 140 whereby the outer flap portion 148 can be folded over the tab 134 when the receptacles 112 are juxtaposed as shown in FIG. 7. The protuberances 156 (or the loading gauges) of the container 110 of FIG. 7 are deflected since the cavities 120 include the predetermined number of coins 180. As mentioned earlier, the protuberances 156 are displaceable under the pressure of the coins to a position indicating that the exact number of coins has been loaded into the coin container.

In order to secure the attachment means, herein the flap 140 and tab 134, a staple 150 may be positioned in the flap 140 as shown in FIG. 7. Other type fasteners may be used for this purpose, such as glue or adhesive tape.

As for the embodiments described previously, at least one cavity 120 includes a protuberance 156 juxtaposed to an end wall 116, preferably proximate to the tab 134 and/or the folding flap 140, protruding inside the cavity 120. The protuberance 156 is flatten when one of the receptacle 112 includes the predetermined number of coins therein and the other receptacle 112 is folded towards the first one as shown in FIG. 7. If the receptacle 112 includes less than the predetermined number of coins therein, the protuberance 156 is not compressed when a receptacle 112 is folded towards the other one.

The coin container 10, 110 is preferably formed of a thin plastic vinyl material having a thickness of approximately 7 mil.

The container 10, 110 can be re-usable. However, once flatten, the protuberances 56, 156 do not protrude inwardly as for a new container 10, 110. Therefore, if coins are inserted in a used container 10, 110 having an already flatten protuberance 56, 156, the latter can no longer be used to indicate if the predetermined number of coins have been inserted.

The coin container allows to hold a precise number of coins of a predetermined denomination in close fit therein and permitting coins to be inserted and removed quickly without the necessity of counting same. The coin container is preferably nestable, when not in use, and does not have any loose parts. Preferably, the container is easy to use and does not require a pre-assembly thereof.

The embodiments of the invention described above are intended to be exemplary only. Even if the containers described above are formed from a sheet of transparent plastic material, one skilled in the art will appreciate that they can be formed with any other appropriate material. The scope of the invention is therefore intended to be limited solely by the scope of the appended claims.

What is claimed is:

1. A coin container comprising at least one compartment adapted to receive a predetermined number of coins or tokens of a predetermined denomination stacked side-by-side therein, said at least one compartment including at least one longitudinal side wall; end faces at opposed ends of said at least one longitudinal side wall; and at least one protuberance projecting inwardly of said at least one compartment, said protuberance being axially deflectable under the pressure of the coins or tokens into a predetermined position indicative of a reaching of a full content capacity of said container.

2. A coin container as claimed in claim 1 comprising two protuberances located at the same end of said at least one longitudinal side wall, each of said protuberance protruding inwardly in said compartment.

3. A coin container as claimed in claim 1 wherein the length of said at least one protuberance is adapted to the denomination of said coins to be stacked in said container.

4. A coin container as claimed in claim 1 comprising a permanent identification marking in said longitudinal side wall to identify predetermined quantities of coins retained in said container when not filled entirely with said coins.

5. A coin container as claimed in claim 1 wherein said protuberance is collapsed when said container has reach is full content capacity.

6. A coin container comprising at least two open-faces receptacles connected along a common edge, each receptacle including:
a longitudinal side wall having an inner surface;
an end wall at opposite ends of each of said longitudinal arcuate side wall, said end walls cooperating with said side wall to circumscribed a cavity adapted to receive an exact number of coins of a predetermined denomination therein; and
at least one of said receptacles including at least one loading gauge displaceable under the pressure of the coins to a position indicating that the exact number of coins has been loaded into the coin container.

7. A coin container as claimed in claim 6 wherein said loading gauge is displaced when said receptacles are folded together from said common edge.

8. A coin container as claimed in claim 6 wherein each of said receptacle comprises a loading gauge, said loading gauges of said receptacles being located at the same end of said longitudinal side wall, each of said loading gauge projecting inwardly of said cavity.

9. A coin container as claimed in claim 6 wherein the length of said at least one loading gauge is adapted to the denomination of said coins to be stacked in said container.

10. A coin container as claimed in claim 6 comprising a permanent identification marking in at least one of said longitudinal side wall to identify predetermined quantities of coins retained in said container when not filled entirely with said coins.

11. A coin container as claimed in claim 6 wherein said receptacles are adapted to be detachably secured in juxtaposition.

12. A coin container as claimed in claim 11 comprising a flange extending outwardly of a longitudinal side wall of one of said receptacles from an outer longitudinal edge thereof opposite said common edge, two or more indentations in said flange space on a longitudinal axis thereof and positioned to receive in friction fit a respective one of two or more protrusion formed in the other of said receptacles and spaced along the longitudinal axis thereof.

13. A coin container as claimed in claim 12 wherein one or more longitudinal expansion ridges are formed longitudinally across said flange between said edge from which said flange extends and said indentations in said flange whereby to exert a retention force on said protrusions matingly engage in said indentations.

14. A coin container as claimed in claim 6 wherein said common edge has a hinge rib formed therealong.

15. A coin container comprising at least two open-faces receptacles connected along a common edge, each receptacle including:
at least one cavity adapted to receive an exact number of coins of a predetermined denomination therein; and
at least one of said receptacles including at least one coin indicator, said at least coin indicator being substantially deformable under the pressure of said coin to indicate that said exact number of coins have been inserted in said receptacle.

16. A coin container as claimed in claim 15 wherein said coin indicator is deformed when said receptacles are folded from said common edge.

17. A coin container as claimed in claim 15 wherein each of said receptacles comprises a coin indicator, said coin indicators being located at the same end of said receptacles, each of said coin indicator projecting inwardly of said cavity when undeformed.

18. A coin container as claimed in claim 15 wherein the shape of said at least one coin indicator is adapted to the denomination of said coins to be stacked in said container.

19. A coin container as claimed in claim 15 comprising a permanent identification marking on at least one of said receptacle to identify predetermined quantities of coins retained in said container when not filled entirely with said coins.

20. A coin container as claimed in claim 15 wherein said receptacles are adapted to be detachably secured in juxtaposition.
